(19) United States
(12) Patent Application Publication
(10) Pub. No.: US 2009/0169376 A1
(43) Pub. Date: Jul. 2, 2009

(54) Turbine Nozzle Segment and Method for Repairing a Turbine Nozzle Segment

(75) Inventors: Clive Andrew Morgan, Cincinnati, OH (US); Todd Stephen Heffron, Harrison, OH (US); Sanjeewa Thusitha Fonseka, Dublin, OH (US); Peter Robert Griffiths, Cincinnati, OH (US)

Correspondence Address: GENERAL ELECTRIC COMPANY, GE AVIATION, ONE NEUMANN WAY MD H17, CINCINNATI, OH, 45215, US

(73) Assignee: General Electric Company

(21) Appl. No.: 11/967,170

(22) Filed: Dec. 29, 2007

(51) Int. Cl. F01D 9/02; F01D 11/08; B23P 6/00

(52) U.S. Cl. 415/209.2; 415/174.2; 29/402.02

(57) ABSTRACT

A turbine nozzle segment includes a first band, an airfoil extending from the first band and a support attached to the first band. The support may have a plurality of circumferentially spaced apart tabs.

### BACKGROUND OF THE INVENTION

The exemplary embodiments relate generally to gas turbine engine components and more specifically to leaf seal assemblies for turbine nozzle assemblies.

Gas turbine engines typically include a compressor, a combustor, and at least one turbine. The compressor may compress air, which may be mixed with fuel and channeled to the combustor. The mixture may then be ignited for generating hot combustion gases, and the combustion gases may be channeled to the turbine. The turbine may extract energy from the combustion gases for powering the compressor, as well as producing useful work to propel an aircraft in flight or to power a load, such as an electrical generator.

The turbine may include a stator assembly and a rotor assembly. The stator assembly may include a stationary nozzle assembly having a plurality of circumferentially spaced apart airfoils extending radially between inner and outer bands, which define a flow path for channeling combustion gases therethrough. Typically the airfoils and bands are formed into a plurality of segments, which may include one (typically called a singlet) or two spaced apart airfoils radially extending between an inner and an outer band. The segments are joined together to form the nozzle assembly.

The rotor assembly may be downstream of the stator assembly and may include a plurality of blades extending radially outward from a disk. Each rotor blade may include an airfoil, which may extend between a platform and a tip. Each rotor blade may also include a root that may extend below the platform and be received in a corresponding slot in the disk. Alternatively, the disk may be a blisk or bladed disk, which may alleviate the need for a root and the airfoil may extend directly from the disk. The rotor assembly may be bounded radially at the tip by a stationary annular shroud. The shrouds and platforms (or disk, in the case of a blisk) define a flow path for channeling the combustion gases therethrough. The nozzles and shrouds are separately manufactured and assembled into the engine. Accordingly, gaps are necessarily provided therebetween for both assembly purposes as well as for accommodating differential thermal expansion and contraction during operation of the engine.

The gaps between the stationary components are suitably sealed for preventing leakage therethrough. In a typical turbine nozzle, a portion of air is bled from the compressor and channeled through the nozzles for cooling thereof. The use of bleed air reduces the overall efficiency of the engine and, therefore, is minimized whenever possible. The bleed air is at a relatively high pressure, which is greater than the pressure of the combustion gases flowing through the turbine nozzle. As such, the bleed air would leak into the flow path if suitable seals were not provided between the stationary components.

A typical seal used to seal these gaps is a leaf seal. A typical leaf seal is arcuate and disposed end to end around the circumference of the stator components. For example, the radially outer band of the nozzle includes axially spaced apart forward and aft rails. The rails extend radially outwardly and abut a complementary surface of an adjoining structural component, such as, but not limited to, a shroud, a shroud hanger, and/or a combustor liner, for providing a primary friction seal therewith. The leaf seal provides a secondary seal at this junction and bridges a portion of the rail and the adjoining structural component. Leaf seals are typically relatively thin, compliant sections, which are adapted to slide along a pin fixed to one of the adjoining structural components.

Regardless of the particular shape of the structural components to be sealed, leaf seals are movable to a closed, sealing position in which they engage each structural component and seal the space therebetween, and an open position in which at least one portion of the leaf seals disengage a structural component and allow the passage of gases in between such components. In most applications, movement of the leaf seals along the pins to a closed position is affected by applying a pressure differential across seal, i.e., relatively high pressure on one side of the seal and comparatively low pressure on the opposite side thereof forces the seal to a closed, sealed position against surfaces of the adjoining structural components to prevent the passage of gases therebetween.

While leaf seals have found widespread use in turbine engines, their effectiveness in creating a fluid tight seal is dependent on the presence of a sufficient pressure differential between one side of the seal and the other. During certain operating stages of a turbine engine, the difference in fluid pressure on opposite sides of the leaf seals is relatively low. Under these conditions, it is possible for the leaf seals to unseat from their engagement with the abutting structural components of the turbo machine and allow leakage therebetween. A relatively small pressure differential across the leaf seals also permits movement or vibration of the leaf seals with respect to the structural components that they contact. This vibration of the leaf seals, which is caused by operation of the turbine engine and other sources, creates undesirable wear both of the leaf seals and the surfaces of the structural components against which the leaf seals rest. Such wear not only results in leakage of gases between the leaf seals and structural components of the turbine engine, but can cause premature failure thereof.

To overcome this problem, other designs have included a biasing structure, such as a spring, to bias the leaf seal toward a certain position. For example, a band may have two circumferentially spaced apart, radially extending tabs spaced axially from a rail. A recess may be formed between the tabs and the rail where the leaf seal and spring are disposed. The tabs, leaf seals and springs may include holes for receiving a pin for mounting to the band. At least one of the tabs is typically spaced apart from the circumferential edges of the band. The tab, leaf seal and spring are arranged so that the spring forces the leaf seal against an adjoining structural component so as to maintain the leaf seal in a closed, sealed position at all times.

In some instances, such as, but not limited to, low emissions combustors, this configuration is not sufficient. For example, low emissions combustors are susceptible to flame instability, which may lead to acoustic resonance and high dynamic pressure variation. The high frequency pressure fluctuations can damage the leaf seals, particularly the leaf seals between the aft edge of the combustor liner and the leading edge of the nozzle bands, by repeatedly loading and unloading the seals against the adjoining structural component. The seals are particularly susceptible to damage where they are unsupported by the springs and/or tabs. The seals may not be fully supported at their circumferential edges and/or between the tabs on the bands.

### BRIEF DESCRIPTION OF THE INVENTION

In one exemplary embodiment, a turbine nozzle segment includes a first band, an airfoil extending from the first band, and a support attached to the first band. The support may have a plurality of circumferentially spaced apart tabs. In another exemplary embodiment, a repaired turbine nozzle segment includes a first band having a ground-in recess, an airfoil extending from the first band, and a support brazed into the recess. The support may have three or more circumferentially spaced apart tabs.

In yet another exemplary embodiment, a method for repairing a turbine nozzle segment may include providing a support having a plurality of tabs, grinding a plurality of tabs from the turbine nozzle segment, and attaching the support to the turbine nozzle segment.

### BRIEF DESCRIPTION OF THE DRAWINGS

FIG. 1 is a cross-sectional schematic view of an exemplary gas turbine engine.

FIG. 2 is a cross-sectional schematic view of an exemplary turbine nozzle assembly.

FIG. 3 is a perspective view of an exemplary turbine nozzle segment.

FIG. 4 is a close-up cross-sectional view of an exemplary turbine nozzle leaf seal assembly.

FIG. 5 is a top view of an exemplary turbine nozzle segment.

FIG. 6 is a flow chart of an exemplary method for repairing a turbine nozzle segment.

### DETAILED DESCRIPTION OF THE INVENTION

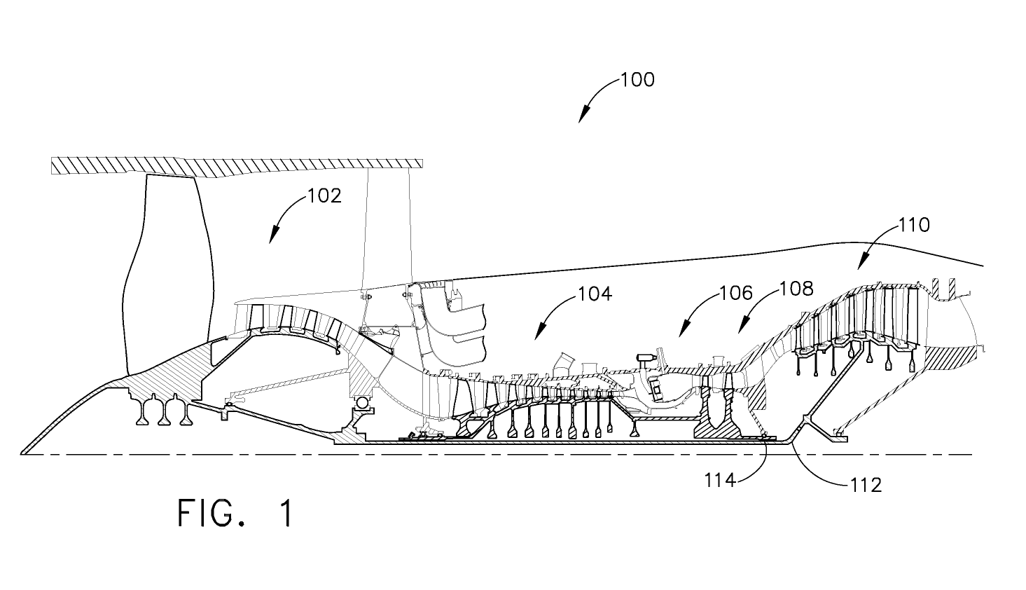

FIG. 1 illustrates a cross-sectional schematic view of an exemplary gas turbine engine 100. The gas turbine engine 100 may include a low-pressure compressor 102, a high-pressure compressor 104, a combustor 106, a high-pressure turbine 108, and a low-pressure turbine 110. The low-pressure compressor may be coupled to the low-pressure turbine through a shaft 112. The high-pressure compressor 104 may be coupled to the high-pressure turbine 108 through a shaft 114. In operation, air flows through the low-pressure compressor 102 and high-pressure compressor 104. The highly compressed air is delivered to the combustor 106, where it is mixed with a fuel and ignited to generate combustion gases. The combustion gases are channeled from the combustor 106 to drive the turbines 108 and 110. The turbine 110 drives the low-pressure compressor 102 by way of shaft 112. The turbine 108 drives the high-pressure compressor 104 by way of shaft 114.

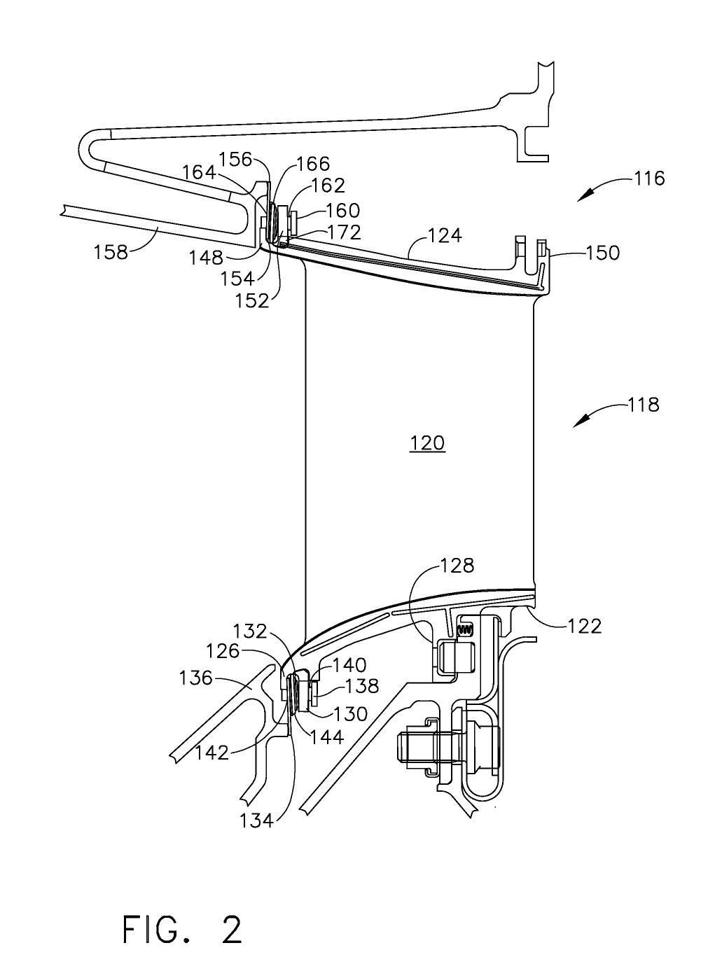

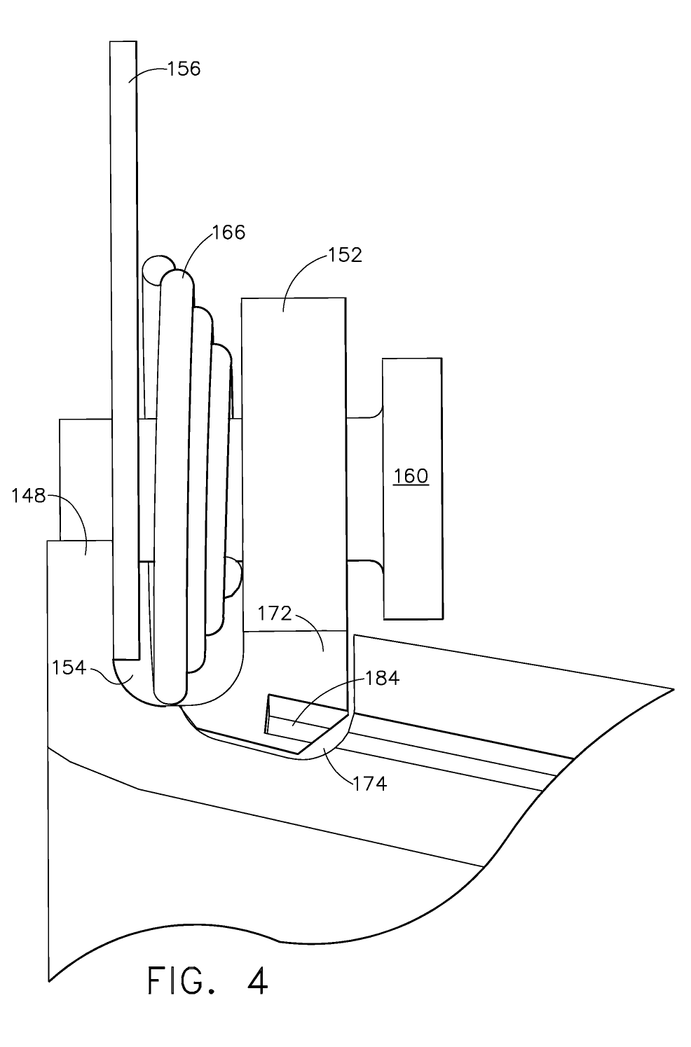

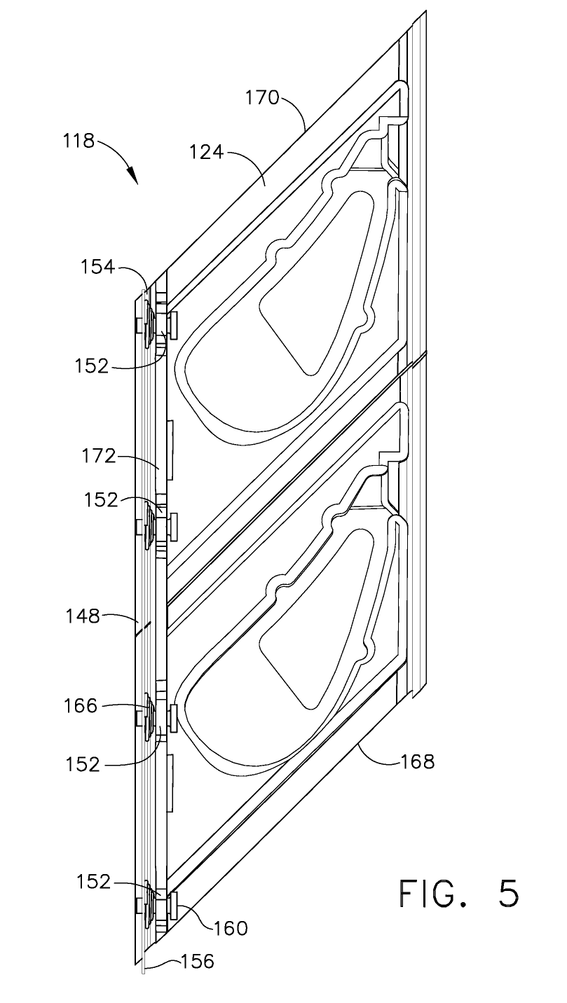

As shown in FIG. 2, the high-pressure turbine 108 may include a turbine nozzle assembly 116. The turbine nozzle assembly 116 may be downstream of the combustor 106 or a row of turbine blades. The turbine nozzle assembly 116 includes an annular array of turbine nozzle segments 118. A plurality of arcuate turbine nozzle segments 118 may be joined together to form an annular turbine nozzle assembly 116. As shown in FIGS. 2-5, the nozzle segments 118 may include one or more airfoils 120 extending between an inner band 122 and an outer band 124. The airfoils 120 may be hollow and have internal cooling passages or may receive one or more cooling inserts. The inner and outer bands 122 and 124 may have one or more axially spaced apart rails for connecting the nozzle segment 118 to upstream and downstream adjoining components.

The inner band 122 may include a forward rail 126 and an aft rail 128. The inner band 122 may also have a plurality of circumferentially spaced apart tabs 130. The tabs 130 may be axially spaced from the forward rail 126 defining a recess 132 between the tabs 130 and the forward rail 126. A leaf seal 134 may be disposed within the recess 132 and positioned to abut an adjoining component. In one exemplary embodiment, the adjoining component may be a combustor liner, such as combustor liner 136. In another exemplary embodiment, the adjoining component may be a turbine shroud. The leaf seal 134 may be retained in the recess 132 with a pin 138. The pin 138 may be positioned through a hole 140 in the tab 130 and a corresponding hole 142 in the leaf seal 134. A biasing structure 144 may be retained by the pin 138 and bias the leaf seal 134 into abutting contact with the adjoining component. The tab 130, pin 138 and biasing structure 144, may be adjacent a circumferential edge 146 and/or a circumferential edge 147 of the nozzle segment 118.

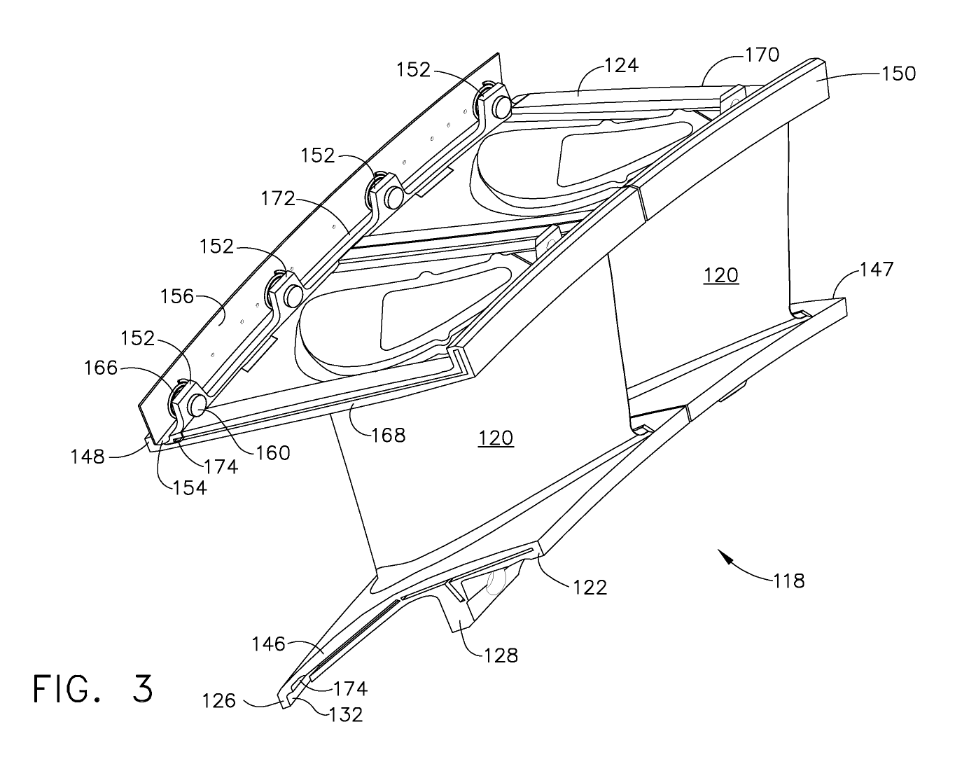

The outer band 124 may include a forward rail 148 and an aft rail 150. The outer band 124 may also have a plurality of circumferentially spaced apart tabs 152. The tabs 152 may be axially spaced from the forward rail 148 defining a recess 154 between the tabs 152 and the forward rail 148. A leaf seal 156 may be disposed within the recess 154 and positioned to abut an adjoining component. In one exemplary embodiment, the adjoining component may be a combustor liner, such as combustor liner 158. In another exemplary embodiment, the adjoining component may be a turbine shroud. The leaf seal 156 may be retained in the recess 154 with a pin 160. The pin 160 may be positioned through a hole 162 in the tab 152 and a corresponding hole 164 in the leaf seal 156. A biasing structure 166 may be retained by the pin 160 and bias the leaf seal 156 into abutting contact with the adjoining component. As shown in FIG. 3, the tab 152, pin 160 and biasing structure 166, may be adjacent a circumferential edge 168 and/or a circumferential edge 170 of the nozzle segment 118.

The tabs 130, 152 may be integral with a support 172, which may be attached to the inner band 122 and/or outer band 124. The support 172 may be attached by brazing, welding, using a fastener or any other attachment method known in the art. In one exemplary embodiment, a recess 174 may be formed in the inner band 122 and/or outer band 124. The support 172 may be attached within the recess 174. The support 172 may include a plurality of tabs 130, 152. In one exemplary embodiment, the support 172 attached to the inner band 122 may have three or more tabs 130, one adjacent to a circumferential edge 146 of the inner band 122, one adjacent to another circumferential edge 147 of the inner band 122, and one or more therebetween. In another exemplary embodiment, the support 172 attached to the outer band 124 may have three or more tabs 152, one adjacent to a circumferential edge 168 of the outer band 124, one adjacent to another circumferential edge 170 of the outer band 124, and one or more therebetween. In yet another exemplary embodiment, the support 172 attached to the inner band 122 may have three or more tabs 130, one adjacent to a circumferential edge 146 of the inner band 122, one adjacent to another circumferential edge 147 of the inner band 122, and one or more therebetween. The support 172 attached to the outer band 124 may also have three or more tabs 152, one adjacent to a circumferential edge 168 of the outer band 124, one adjacent to another circumferential edge 170 of the outer band 124, and one or more therebetween.

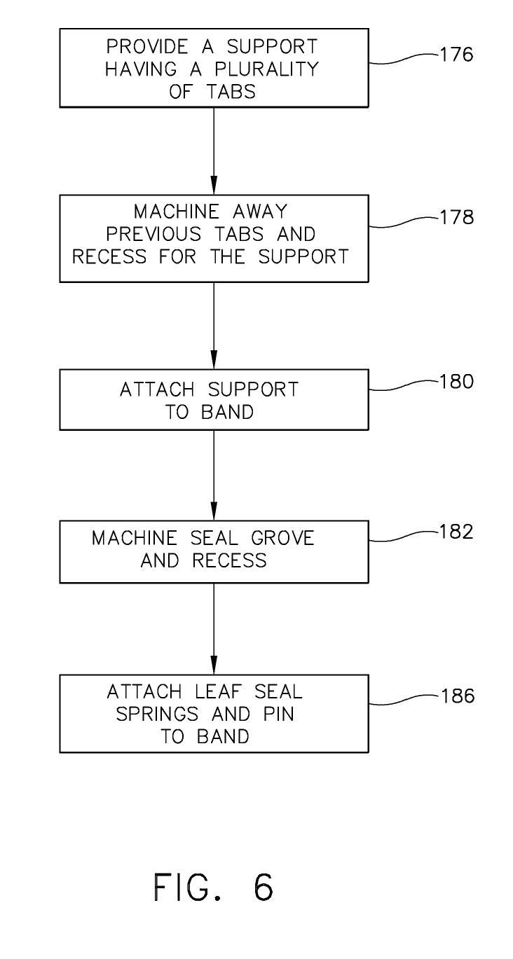

FIG. 6 illustrates a flow chart for an exemplary method for repairing a worn turbine nozzle segment. In one exemplary embodiment, a support 172 having a plurality of tabs 152 is provided at step 176. The support 172 may be cast as a one-piece structure as is known in the art. Next, the tabs 152 on the at least one band are machined away at step 178. As used herein, machining may include any or all of the following: grinding, milling, laser machining, electrodischarge machining, electrochemical machining or any other similar process that removes material from a component. Next, a recess 174 may be formed in the band for receiving the support 172. The recess 174 may be formed concurrently with step 178 or separately as its own step. At step 180, the support 172 is attached to the band at the recess 174 through brazing or any other attachment method. At step 182, a seal groove 184 and recess 132, 154 may be formed by machining away material left from the attachment step 180. Next, the leaf seal 156, pins 160 and biasing structures 166 are assembled to the tabs 152 on the support 174 at step 186.

During operation, the leaf seals are biased into abutting contact with adjoining components to provide sealing between the turbine nozzle segment and the adjoining components. The exemplary embodiments described provide additional support to the leaf seals in areas susceptible to damage, such as, but not limited to, areas adjacent to the circumferential edges of the inner and/or outer bands and the central areas therebetween. The exemplary embodiments may also increase the mechanical sealing load and reduce the unsupported length of the leaf seals.

This written description discloses exemplary embodiments, including the best mode, to enable any person skilled in the art to make and use the exemplary embodiments. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A turbine nozzle segment, comprising:
a first band;
an airfoil extending from said first band; and
a support attached to said first band, said support having a plurality of circumferentially spaced apart tabs.

2. The turbine nozzle segment of claim 1 wherein at least one of said plurality of tabs is adjacent a circumferential edge of said first band.

3. The turbine nozzle segment of claim 2 wherein said plurality of tabs are integral with said support.

4. The turbine nozzle segment of claim 3 further comprising:
a second band;
wherein said airfoil extends between said first band and said second band.

5. The turbine nozzle segment of claim 4 further comprising:
a rail extending from said first band and spaced from said plurality of tabs defining a recess therebetween; and
a leaf seal disposed in said recess.

6. The turbine nozzle segment of claim 5 further comprising:
a pin extending through each of said tabs and said leaf seal; and
a biasing structure associated with each of said pins and biasing said leaf seal in abutting contact with an adjoining component.

7. A repaired turbine nozzle segment, comprising:
a first band having a machined-in recess;
an airfoil extending from said first band; and
a support brazed into said recess, said support having three or more circumferentially spaced apart tabs.

8. The repaired turbine nozzle segment of claim 7 wherein one of said tabs is adjacent a first circumferential edge of said first band and one of said tabs is adjacent a second circumferential edge of said first band.

9. The repaired turbine nozzle segment of claim 7 wherein said tabs are integral with said support.

10. The repaired turbine nozzle segment of claim 7 further comprising:
a second band;
wherein said airfoil extends between said first band and said second band.

11. The repaired turbine nozzle segment of claim 7 further comprising:
a rail extending from said first band and spaced from said tabs defining a recess therebetween; and
a leaf seal disposed in said recess.

12. The repaired turbine nozzle segment of claim 11 further comprising:
a pin extending through each of said tabs and said leaf seal; and
a biasing structure associated with each of said pins and biasing said leaf seal in abutting contact with an adjoining component.

13. The repaired turbine nozzle segment of claim 8 further comprising:
a rail extending from said first band and spaced from said tabs defining a recess therebetween; and
a leaf seal disposed in said recess.

14. The repaired turbine nozzle segment of claim 13 further comprising:
a pin extending through each of said tabs and said leaf seal; and
a biasing structure associated with each of said pins and biasing said leaf seal in abutting contact with an adjoining component.

15. A method for repairing a turbine nozzle segment, comprising:
providing a support having a plurality of tabs;
machining a plurality of tabs from said turbine nozzle segment; and
attaching said support to said turbine nozzle segment.

16. The method for repairing a turbine nozzle segment of claim 15 further comprising:
machining a seal groove into said support.

17. The method for repairing a turbine nozzle segment of claim 15 further comprising:
machining a recess into said turbine nozzle segment.

18. The method for repairing a turbine nozzle segment of claim 17 further comprising:
machining a second recess into said turbine nozzle segment.

19. The method for repairing a turbine nozzle segment of claim 18, further comprising:
attaching a leaf seal, biasing structure and pin to each of said plurality of tabs.

20. The method for repairing a turbine nozzle segment of claim 15, further comprising:
attaching a leaf seal, biasing structure and pin to each of said plurality of tabs.
